(19) United States
(12) Patent Application Publication
(10) Pub. No.: US 2003/0019725 A1
(43) Pub. Date: Jan. 30, 2003

(54) Material guiding system for splicing machines

(76) Inventor: Bernd Hoffmann, Burgkunstadt (DE)

Correspondence Address: JORDAN AND HAMBURG LLP, 122 EAST 42ND STREET, SUITE 4000, NEW YORK, NY, 10168, US

(21) Appl. No.: 10/103,225

(22) Filed: Mar. 20, 2002

(30) Foreign Application Priority Data
Apr. 21, 2001 (DE) 101 19 508.7-22

(51) Int. Cl. B65G 37/00

(52) U.S. Cl. 198/571

(57) ABSTRACT

A material guiding system, particularly for splicing machines, with a belt conveyor system, on which a corded tape strip is conveyed to a specified splicing line, the tape transporting system consisting of a plurality of individually controllable conveyor belts or groups of conveyor belts, the driving mechanism of which can be controlled by the leading and/or trailing edge of the corded tape strip.

The invention relates to a material guiding system, particularly for splicing machines, with a tape transporting system, on which a corded tape strip is conveyed to a specified splicing line.

When the frequently very thin and soft corded tape strips are conveyed, the difficulty arises that, due to irregularities during the transfer or the running of the tape, the edges of the corded tape strips are bent. As a result, when butt splicing, the edges of two strips do not coincide and, when splicing with overlap, the splicing is not uniform, so that a satisfactory splicing process is not possible.

It is therefore an object of the invention to create a material guiding system, which permits corded tape strips to be aligned with their material edges accurately on the splicing line, even when they arrive bent on the transporting system.

This objective is accomplished pursuant to the invention owing to the fact that the tape transporting system consists of a plurality of conveyor belts or groups of conveyor belts, which can be controlled individually and the driving mechanism of which can be controlled by the leading and/or trailing edge of the corded tape strip, especially owing to the fact that a sensor, lying on the specified splicing line or on a line, which is parallel thereto and disposed in front of the splicing line in the transporting direction, for triggering the respective conveyor belt driving device, is provided for each conveyor belt or group of conveyor belts.

Due to the inventive development, it is possible to stop the driving mechanism of the conveyor belt, on which the region of the leading or trailing edge is leading most, when the respective sensor is reached, while the others continue to run, until they have also reached the inner sections of the respective sensor, in order to achieve an alignment of the edges of the corded tape strip in this manner.

Aside from stopping the respective conveyor belt or group of conveyor belts when the respective sensor is reached, it is also possible that a decelerated movement takes place either up to a second sensor or over a specified, adjustable after-running distance, in order to achieve a greater or lesser overlapping in this manner.

Moreover, it is also within the scope of the invention that, with the stopping of the conveyor belt or of a group of conveyor belts, the supported section of the corded tape strip is fixed by a press die or the like, so that it is ensured that this corded tape strip is not shifted by adjacent sections, which continue to move, although the conveyor belt, on which this corded tape section is resting, has already been stopped.

It is obvious, that this material guiding system is not limited to splicing machines, in which the splicing edge is perpendicular to the transporting direction of the tape transporting system. Instead, a splicing line, for which the leading and trailing edges of the corded tape strip are aligned with the help of the inventive measure, can also be provided at an angle to the axis of the belt conveyor.

The sensors are located between the ends of the conveyor belt supplying system and the conveyor belt discharging system directly in the region of the splicing device. A narrow overrunning strip may also be provided between the two conveyor belts in order to ensure splicing by overlapping. The sensors are provided underneath this overrunning strip, which can be tipped so that the trailing edge of the running-out tape, aligned over the sensors, can be moved away downward, so that the leading edge of the next corded tape strip can be moved over it by a certain overlapping distance. Subsequently, the tipped splicing table is raised once again and the splicing takes place in the known manner.

With particular advantage, provisions can be made in a development of the invention so that the conveyor belts or groups of conveyor belts stop not directly at the place of the sensors, but instead a few millimeters behind this place. This has the advantage that the trailing edge of the corded tape strip running out, as well as the leading edge of the corded tape strip running in can be aligned with a sensor line. Namely, in the case of such a delay, the trailing edge is located somewhat behind the sensors then lying free once again, as seen in the conveying direction of the tape, so that the same sensors can assume the control of the leading edge of the corded tape strip running in. The extent, to which the corded tape strip running in is moved even further over the sensor line depends on whether a butt joint or an overlapping joint is to be produced by the splicing.

Further advantages, distinguishing features and details of the invention arise out of the following description of an example as well as out of the drawing, in which the mode of operation of the inventive material guiding system is explained diagrammatically. In the drawing

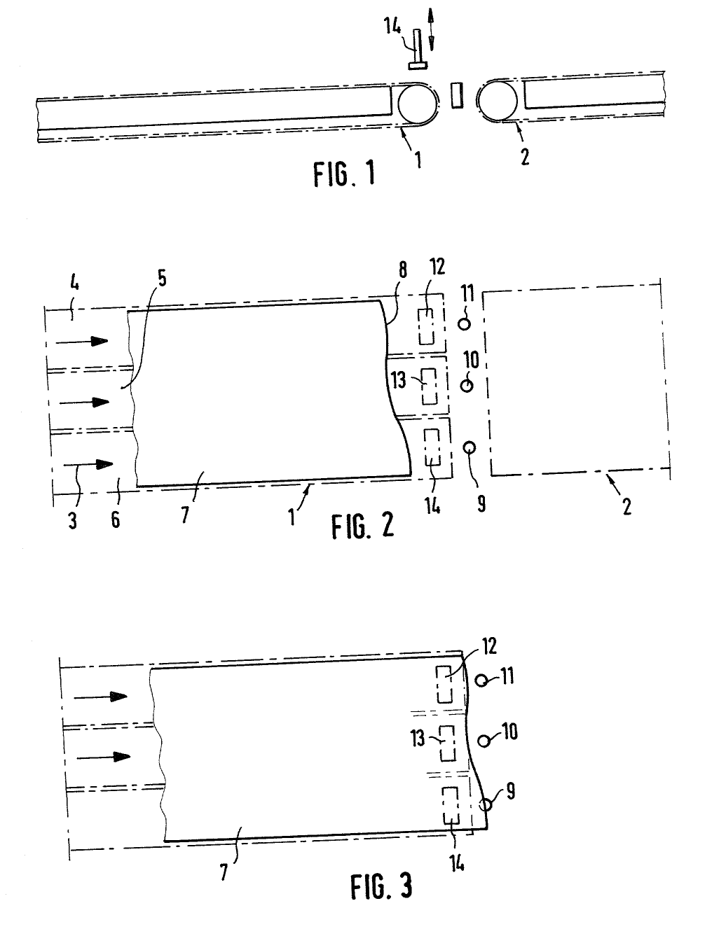

FIG. 1 shows a diagrammatic side view of the tape transporting system in the region of the splicing line, the actual splicing device and a splicing table, which may have been provided, being omitted for reasons of greater clarity. Only those components are shown, which are required for the inventive conveyor belt control for aligning the corded tape strip edges,

FIG. 2 shows a view of the arrangement of FIG. 1 with a corded tape strip, which is to be supplied, having a wavy front edge,

FIG. 3 shows a view, corresponding to that of FIG. 2, in the position, in which the leading end of the corrugated front edge of the corded tape strip has reached the associated sensor,

FIG. 4 shows a further intermediate stage, in which a second belt unit has also been stopped,

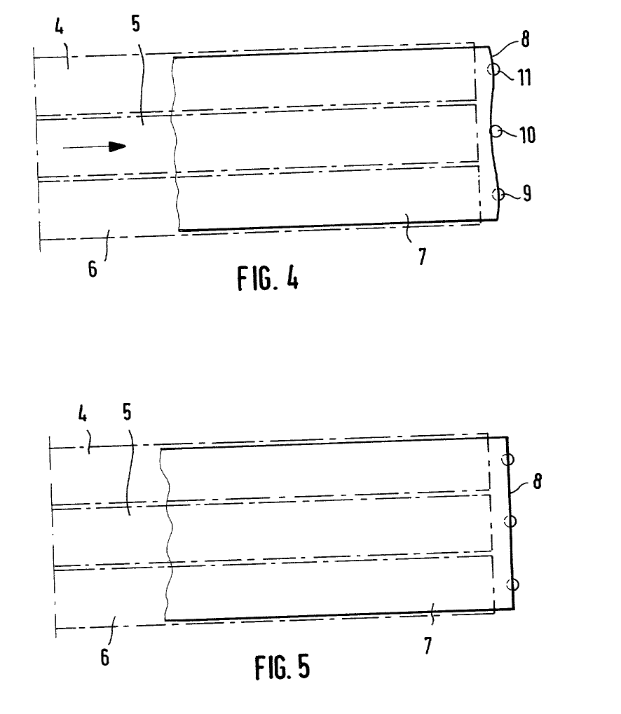

FIG. 5 shows the end position, in which the front edge of the corded tape strip is aligned straight by in the individual belt units, which can be stopped,

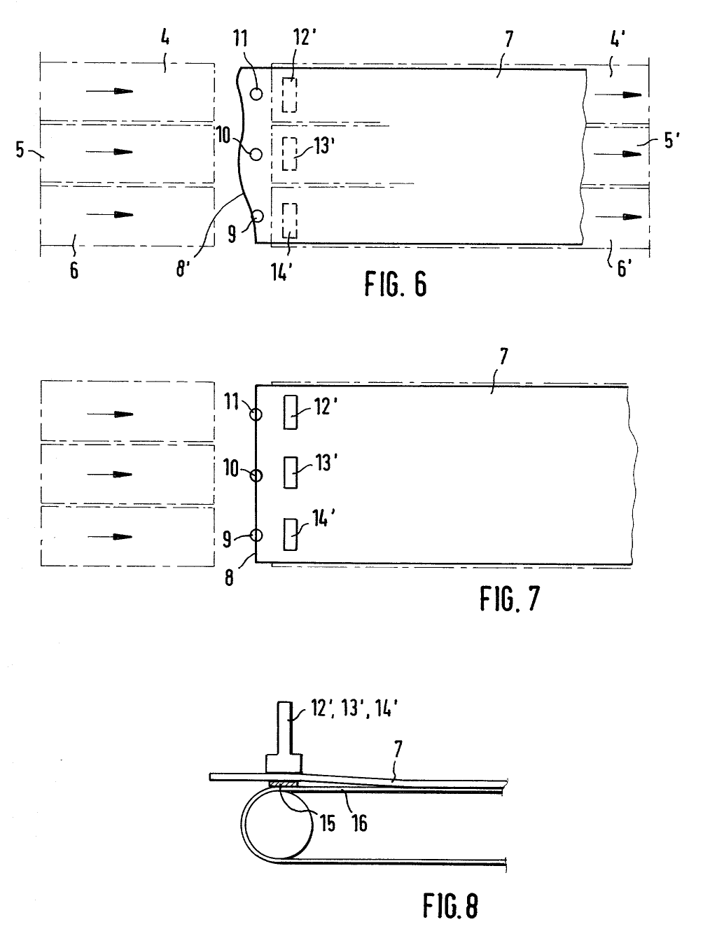

FIGS. 6 and 7 shows views, corresponding to those of FIGS. 3 and 5, during the alignment of the trailing edge of the corded tape strip and

FIG. 8 shows a diagrammatic side view of FIG. 1 with an undivided discharging belt.

The tape transporting system shown comprises a supplying transporting system 1 and, a short distance thereafter, a discharging transporting system 2. Between the two, there is a splicing device, which is not shown. In the Figures, an example is shown, for which the splicing line extends perpendicularly to the conveying direction 3 of the transporting system. However, the inventive material guiding system is also suitable for corded tape strips with leading and trailing edges disposed obliquely to the conveying direction 3.

The tape transporting systems 1 and 2 in FIGS. 1 to 7 consists of a plurality of conveyor belts, which can be controlled individually or in groups. In the example shown, three groups of conveyor belts 4, 5 and 6 are provided. These may be individual belts or a plurality of belts, which are coupled together so that they can be operated by a common driving mechanism. A corded tape strip 7 rests on the three groups of conveyor belts 4 to 6 of the supplying tape transporting system 1. The leading edge 8 of this corded tape strip 7, as can be seen in FIGS. 2 and 3, does not extend perpendicularly to the direction 3, in which the tape is moving, and is therefore not parallel to the splicing edge. Instead, it is corrugated. In order to make it possible to align this corrugated leading edge 8, which can be caused time and a gain by tensions in the material and, with that, then also actually achieve a satisfactory splicing of this corded tape strip coming in with a corded tape strip, which is shown for the first time in FIG. 7 and already rests on the discharging tape transporting system 2, conveyor belt groups can be controlled separately by sensors 9, 10 and 11 lying in the splicing line 15 or in a line parallel thereto.

As soon as the leading edge of the leading section of the leading edge 8 reaches the associated sensor 9, the latter causes the driving system for the conveyor belt group 6 to stop, so that the lower third of the corded tape strip 7 is not conveyed further. The other two groups of conveyor belt groups 5 and 4 in the upper third continue to run until, as shown in FIG. 4, the leading edge 8 has reached the associated sensor 11, at which time the conveyor belt group of 4 is stopped. Subsequently, the central conveyor belt group 5 still moves a certain distance further, until finally an alignment to a straight leading edge 8 is achieved, as shown in FIG. 5.

At 12, 13 and 14, press dies are indicated, which are actuated automatically when the conveyor belt group beneath them is stopped in order to fix the section of corded tape strip resting thereon, so that it is not carried along partially over the stationary conveyor belt group by the adjacent tapes, which continue to move, so that the desired exact alignment is not endangered. Instead of stopping and blocking the corded tape strip section by such a press die, provisions could also be made in the case of steel corded tape strips so that magnets are disposed in the conveyor belts and prevent slipping. In the case of textile corded tapes, a brake would be conceivable, for which suction strips are disposed below the perforated conveyor belts in the region of the splicing line and ensure, in the same manner, that the corded tape strip section, resting on the respective conveyor belt, sticks firmly and, with that, when the conveyor belt is stopped, further slippage of the corded tape strip section jointly with the adjacent corded tape strip sections, which are still being moved by the conveyor belts disposed beneath them, is prevented.

FIGS. 6 and 7 show the alignment of the trailing edge 8′ of a spliced corded tape strip 7, which is transported further by its length on the discharging conveyor belt group. The mode of functioning corresponds to the alignment of the leading edge in FIGS. 1 to 5. The bent trailing edge 8′ is aligned by means of the sensors 9, 10 and 11 and the press dies 12′, 13′ and 14′ in the same manner described further above in conjunction with the leading edge 8. In this case also, either magnets in the conveyer belt groups 4′, 5′, 6′ or suction strips under perforated groups of conveyor belts can be provided instead of the press dies 12′, 13′, 14′ for fixing the corded tape strip 7 with the respectively stopped conveyor belt group 4′, 5′, 6′. In the example shown, initially the conveyor belt group 6′ is stopped, followed by the conveyor belt 5′ and finally the conveyor belt 4′, in order to achieve the accurate alignment of the trailing edge 8′ of FIG. 7.

The invention is not limited to the example presented. Aside from a splicing line, disposed obliquely to the running direction 3 of the tape, provisions can be made that, when a sensor is reached, the respective conveyor belt group, instead of being stopped suddenly, initially is decelerated and, only after having traveled a specified distance, is finally brought to a stop, in order to achieve a slower, softer alignment of the leading edge 8.

In addition, provisions can also be made so that the groups of conveyor belts are held only when the edge 8 of the corded tape strip has traveled a few millimeters past the position of the respective sensor. In this way, the trailing edge (not shown) of the corded tape strip running out is then caused to rest on the tape transporting system 2 on the right, next to the line of sensors 9, 10 and 11, so that the very same sensors can also be used to align the leading edge 8 of the corded tape strips 7 supplied and, moreover, irrespective of whether the splicing is to be a butt splicing or an overlap splicing.

Moreover, it is also still within the scope of the invention to provide, instead of a divided, discharging conveyor belt group with conveyor belts or groups of conveyor belts 4′, 5′, 6′, a common discharging conveyor belt, which extends continuously over the whole width, and, moreover, in conjunction with the press dies 12′, 13′ and 14′. In the case of this embodiment, a stationary piece of sheet metal or a strip is provided additionally underneath the press dies and, moreover, between the corded tape strip 7 and the discharging conveyor belt. If now one of the dies 12′, 13′, 14′ is lowered from above onto the corded tape strip 7, it clamps the latter against the sheet metal strip 15 in FIG. 8. In contrast to the adjacent strip, onto which the die has not yet been lowered, this section of the corded tape strip 7 is held. At the same time, however, the conveyor belt can continue to move under the sheet metal strip 15, even in the clamped region of the corded tape strip 7. The friction between the sheet metal strip 15 and the conveyor belt is sufficiently small. This functions only at the discharging conveyor belt, that is, for aligning the trailing edge 8′ and not for aligning the leading edge 8 of the corded tape strip, since the conveyor belt can slide away even under the region of the corded strip, which is held fast. At the leading edge, a pushing together of the tape material and a deformation by compression would occur.

1. A material guiding system, particularly for splicing machines, with a tape transporting system, on which a corded tape strip is conveyed to a specified splicing line, wherein the tape transporting system (1, 2) consists of a plurality of individually controllable conveyor belts or groups of conveyor belts (4, 5, 6), the driving mechanism of which can be controlled by the leading and/or trailing edge (8) of the corded tape strip (7).

2. The material guiding system of claim 1, wherein a sensor (9, 10, 11) lying on the specific splicing line or a line, disposed parallel thereto and, in the transporting direction, disposed in front of the splicing line, is assigned to each conveyor belt or conveyor belt group (4, 5, 6) for triggering the respective conveyor belt driving device.

3. The material guiding systems of claims 1 or 2, wherein, when the sensor (9, 10 11) responds, the respective conveyor belt driving device is stopped or braked.

4. The material guiding system of one of the claims 1 to 3, wherein, with the stopping of the conveyor belt or a group of conveyor belts (4, 5, 6) over a locking device (12, 13, 14), the section of the corded tapes strip (7), resting on the conveyor belt, is fixed in position.

5. The material guiding system of claim 3, wherein the locking device comprises press dies (12, 13, 14; 12′, 13′, 14′).

6. The material guiding system of claim 4, wherein the conveyor belts are provided with incorporated magnets for guiding steel corded tape strips.

7. The material guiding system of claim 4, wherein, for guiding textile corded tape strips, the locking device is formed by suction strips, disposed underneath the groups of conveyor belts (4, 5, 6; 4′, 5′, 6′), in conjunction with perforations in the conveyor belts.

8. The material guiding system of one of the claims 1 to 7, wherein the conveyor belts or groups of conveyor belts (4, 5, 6) are stopped with delay in such a manner, that the aligned leading or trailing edge (8) of the corded tape strips (7) lies parallel next to the line of sensors (9, 10, 11).

9. The material guiding system of one of the claims 1 to 8, wherein, for discharging the corded tape strip (7), an undivided conveyor belt is used in conjunction with the locking press dies (12′, 13′, 14′), a rail or a sheet metal strip (15), which enables the conveyor belt below to slide even in the clamped state, being provided between the corded tape strip (7) and the conveyor belt.
